(19) United States
(12) Patent Application Publication
(10) Pub. No.: US 2013/0140962 A1
(43) Pub. Date: Jun. 6, 2013

(54) SPINDLE MOTOR

(71) Applicant: SAMSUNG ELECTRO-MECHANICS CO., LTD., Suwon (KR)

(72) Inventors: Dong Woo Rhee, Gyunggi-do (KR); Young Sun Yoo, Gyunggi-do (KR); Kyung Seob Shin, Gyunggi-do (KR); Pyo Kim, Gyunggi-do (KR)

(73) Assignee: SAMSUNG ELECTRO-MECHANICS CO., LTD., Suwon (KR)

(21) Appl. No.: 13/691,550

(22) Filed: Nov. 30, 2012

(30) Foreign Application Priority Data
Dec. 2, 2011 (KR) 10-2011-0128363

(51) Int. Cl. G11B 19/20; H02K 7/08

(52) U.S. Cl. CPC G11B 19/2009; H02K 7/088
USPC 310/67 R; 310/90

(57) ABSTRACT

Disclosed herein is a spindle motor including: a shaft; a rotor case coupled to the shaft to rotate integrally with the shaft and including a rotor magnet coupled to an inner portion thereof; a base plate to which the shaft is rotatably coupled; a bearing coupled to an outer peripheral surface of the shaft to rotatably support the shaft; a bearing holder coupled to an outer peripheral surface of the bearing to support the bearing and fixedly coupled to an upper portion of the base plate; and a stator core part coupled to an outer peripheral surface of the bearing holder so as to face the rotor magnet, wherein the bearing has a length of an inner peripheral surface contacting the shaft longer than a length of an outer peripheral surface contacting the bearing holder.

### CROSS REFERENCE TO RELATED APPLICATION

This application claims the benefit of Korean Patent Application No. 10-2011-0128363, filed on Dec. 2, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor is a device that is mounted in a hard disk drive, an optical disk drive, and other recording media for requiring high-speed rotation to drive a turntable so as to rotate a disk mounted in the turntable.

A general spindle motor includes a rotor part configured of a shaft and a rotor case and a stator part configured of a bearing rotatably supporting the shaft, an armature configured of a core assembly formed by stacking a plurality of core layers and a coil wound several times around the core assembly, a base plate including a printed circuit board coupled to an upper portion thereof, and a chucking assembly including a turntable mounted with a disk.

Recently, in a drive device formed to be thin, as an internal height of the drive device has been reduced, a length of the bearing rotatably supporting the shaft has gradually reduced.

However, in the case in which the length of the bearing is reduced, an outer diameter ratio of the shaft is increased to cause a leverage phenomenon in the spindle motor, such that vertical movement displacement of the rotor part and wobble performance are deteriorated. Therefore, an error in signal reading may be generated in the drive device and a design margin may be reduced, such that performances of the spindle motor and the drive device mounted with the spindle motor may be deteriorated.

### SUMMARY OF THE INVENTION

The present invention has been made in an effort to provide a spindle motor capable of not increasing an axial gradient and vertical/horizontal movement displacement of a rotor part by reducing an internal height of the spindle motor while maintaining the entire height of a bearing.

According to a preferred embodiment of the present invention, there is provided a spindle motor including: a shaft; a rotor case coupled to the shaft to rotate integrally with the shaft and including a rotor magnet coupled to an inner portion thereof; a base plate to which the shaft is rotatably coupled; a bearing coupled to an outer peripheral surface of the shaft to rotatably support the shaft; a bearing holder coupled to an outer peripheral surface of the bearing to support the bearing and fixedly coupled to an upper portion of the base plate; and a stator core part coupled to an outer peripheral surface of the bearing holder so as to face the rotor magnet, wherein the bearing has a length of an inner peripheral surface contacting the shaft longer than a length of an outer peripheral surface contacting the bearing holder.

The bearing may include a cutting part formed at the outer peripheral surface facing an upper surface of the inner portion of the rotor case, and the length of the inner peripheral surface of the bearing may be longer than the length of the outer peripheral surface thereof.

The cutting part may have an oblique line shape having a gradient in which the cutting part is inclined from an upper portion of the outer peripheral surface of the bearing toward the bearing holder.

The cutting part may have a terraced step shape in which the cutting part is stepped from an upper portion of the outer peripheral surface of the bearing toward the bearing holder.

The rotor case may include: a shaft support part fixedly installed to the shaft; a step part formed in a bearing direction and having a step shape; a disk part extended from a distal end of the step part in an outer diameter direction; and an edge part downwardly extended from a distal end of the disk part in a vertical direction and having an annular shape, wherein the rotor magnet is attached to an inner portion of the edge part of the annular edge part.

The stator core part may include: a stator core formed by stacking a plurality of metal plates; and a coil wound around an outer peripheral surface of the stator core several times.

The spindle motor may further include: a printed circuit board coupled to an upper portion of the base plate and applying power to the armature; and a disk chucking device coupled to an upper surface of the rotor case.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an assembled cross-sectional view of a spindle motor according to a first preferred embodiment of the present invention; and

FIG. 2 is an assembled cross-sectional view of a spindle motor according to a second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

### First Preferred Embodiment

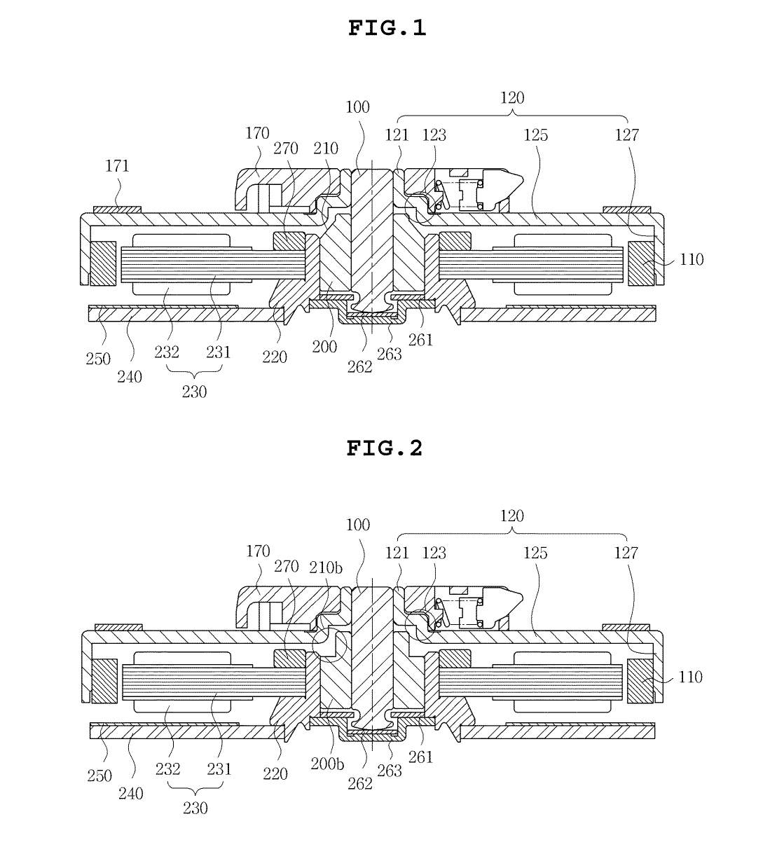

FIG. 1 is an assembled cross-sectional view of a spindle motor according to a first preferred embodiment of the present invention. As shown in FIG. 1, the spindle motor is configured to include a rotor part including a shaft 100, a rotor magnet 110, and a rotor case 120 and a stator part including a bearing 200, a bearing holder 220, a stator core part 230, a base plate 240, and a printed circuit board 250.

The shaft 100 is inserted into a hollow hole having a cylindrical shape and formed at a central portion of the rotor case 120 to shaft-support the rotor case 120, thereby rotating integrally with the rotor case 120.

The cylindrical hollow hole formed at the central portion of the rotor case 120, which is an upper case of the spindle motor, is inserted with shaft 110, and the rotor case 120 rotates integrally with the shaft 100 according to the rotation of the shaft 100.

More specifically, the rotor case 120 includes a shaft support part 121, a step part 123, a disk part 125, and an edge part 127.

As described above, the shaft 100 is fixedly installed to the cylindrical hollow hole formed in the shaft support part 121.

In addition, the step part 123 may have a step shape formed from a distal end of the shaft support part 121 toward the bearing 200.

Further, the disk part 125 is formed to be extended from a distal end of the step part 123 in an outer diameter direction so as to be in parallel with the base plate 240.

Furthermore, the edge part 127 is downwardly extended from a distal end of the disk part 125 toward the base plate 240 in a vertical direction and has an annular shape.

In addition, an inner surface of the annular edge part 127 is attached with the rotor magnet 110 generating electromagnetic force by electromagnetic interaction with the stator core part 230 to rotate the rotor case 120.

Further, an upper portion of the rotor case 120 may be provided with a disk chucking device 170 for chucking the disk and an upper portion of the disk part 125 may be coupled to a slip prevention member 171 for preventing slip of the disk.

As shown in FIG. 1, the bearing 200 configuring the stator part rotatably supports the shaft 100 and an outer peripheral surface thereof is supported by the bearing holder 220 including the cylindrical hollow hole.

The bearing 200 includes a cutting part 210 formed at an outer peripheral surface facing an upper surface of an inner portion of the rotor case 120.

More specifically, the cutting part 210 may have an oblique line shape having a gradient in which the cutting part 210 is inclined from an upper portion of an outer peripheral surface of the bearing 200 toward the bearing holder 220.

Therefore, the bearing 200 according to the first preferred embodiment of the present invention is formed to have a length of an inner peripheral surface contacting the shaft 100 longer than that of the outer peripheral surface contacting the bearing holder 220.

Therefore, the bearing 200 includes the oblique line shaped cutting part 210 having a gradient, such that the above-mentioned rotor case 120 is designed to be closer to a base plate 240 to be described below and thus the spindle motor is designed to have a low internal height, thereby enabling a design for thinness of the spindle motor.

In addition, since the length of the inner peripheral surface of the bearing 200 rotatably supporting the shaft 100 configuring the rotor part is not changed although the spindle motor becomes thin, an axial gradient and vertical/horizontal movement displacement of the rotor part may not be increased.

The bearing holder 220 is inserted into a coupling groove formed in the base plate 240 to thereby be fixedly coupled to an upper portion of the base plate 240.

In addition, an outer peripheral surface of the bearing holder 220 is provided with a step part so as to form a coupling surface to which the stator core part 230 is fixedly coupled.

The stator core part 230 is to form an electric field applied with external power and is configured to include a stator core 231 and a coil 232 wound around the stator core 231.

More specifically, the stator core 231 is formed by stacking a plurality of core layers made of a metal material.

Further, the coil 232 is wound around an outer peripheral surface of the stator core 231 several times so as to form the electric field using power applied from the outside.

Therefore, the stator core part 230 is seated to the coupling surface of the bearing holder 220 and fixedly coupled thereto so as to face the rotor magnet 110 coupled to the annular edge part 127.

The base plate 240 is to entirely support components configuring the spindle motor and is bonded to a disk driving device on which the spindle motor is mounted.

In addition, the printed circuit board 250 having a plurality of electronic components (not shown) mounted thereon is fixedly coupled to the upper portion of the base plate 240.

In addition, the printed circuit board 250 may be adhered to the base plate 240 by a method such as double-sided tape, screwing, rivet, caulking, or the like, and a circuit pattern (not shown) supplying power to the stator core part 230 is formed on the printed circuit board 250.

In addition, a lower end portion of the shaft 100 is installed with a stopper 261 so as to prevent a separation of the shaft 100.

Further, the shaft 100 is axially supported by a thrust washer 262, wherein the thrust washer 262 is fixedly installed to a thrust washer cap 263.

### Second Preferred Embodiment

FIG. 2 is an assembled cross-sectional view of a spindle motor according to a second preferred embodiment of the present invention. In describing the present embodiment, the same or corresponding components to the foregoing preferred embodiments are denoted by the same reference numerals and therefore, the description of the overlapping portions will be omitted. Hereinafter, the spindle motor according to the present embodiment will be described with reference to FIG. 2.

As shown in FIG. 2, a bearing 200b configuring the spindle motor includes a cutting part 210b formed at an outer peripheral surface facing an upper surface of an inner portion of a rotor case 120.

More specifically, the cutting part 210b may have a terraced step shape in which the cutting part 210b is stepped from an upper portion of an outer peripheral surface of the bearing 200b toward a bearing holder 230.

Therefore, the bearing 200b according to the second preferred embodiment of the present invention is formed to have a length of an inner peripheral surface contacting a shaft 100 longer than that of the outer peripheral surface contacting the bearing holder 220.

Therefore, the bearing 200b includes the cutting part 210b having the terraced step shape, such that the above-mentioned rotor case 120 is designed to be closer to a base plate 240 to be described below and thus the spindle motor is designed to have a low internal height, thereby enabling a design for thinness of the spindle motor.

In addition, since a length of the inner peripheral surface of the bearing 200b rotatably supporting the shaft 100 configuring the rotor part is not changed although the spindle motor is thin, an axial gradient and vertical/horizontal movement displacement of the rotor part may not be increased.

According to the preferred embodiment of the present invention, the yield of the manufacturing process of the spindle motor may be improved.

In addition, the internal height of the spindle motor is reduced, such that the drive device may be thin

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a shaft;
a rotor case coupled to the shaft to rotate integrally with the shaft and including a rotor magnet coupled to an inner portion thereof;
a base plate to which the shaft is rotatably coupled;
a bearing coupled to an outer peripheral surface of the shaft to rotatably support the shaft;
a bearing holder coupled to an outer peripheral surface of the bearing to support the bearing and fixedly coupled to an upper portion of the base plate; and
a stator core part coupled to an outer peripheral surface of the bearing holder so as to face the rotor magnet,
wherein the bearing has a length of an inner peripheral surface contacting the shaft longer than a length of an outer peripheral surface contacting the bearing holder.

2. The spindle motor as set forth in claim 1, wherein the bearing includes a cutting part formed at the outer peripheral surface facing an upper surface of the inner portion of the rotor case, and the length of the inner peripheral surface of the bearing is longer than the length of the outer peripheral surface thereof.

3. The spindle motor as set forth in claim 2, wherein the cutting part has an oblique line shape having a gradient in which the cutting part is inclined from an upper portion of the outer peripheral surface of the bearing toward the bearing holder.

4. The spindle motor as set forth in claim 2, wherein the cutting part has a terraced step shape in which the cutting part is stepped from an upper portion of the outer peripheral surface of the bearing toward the bearing holder.

5. The spindle motor as set forth in claim 1, wherein the rotor case includes:
a shaft support part fixedly installed to the shaft;
a step part formed in a bearing direction and having a step shape;
a disk part extended from a distal end of the step part in an outer diameter direction; and
an edge part downwardly extended from a distal end of the disk part in a vertical direction and having an annular shape,
wherein the rotor magnet is attached to an inner portion of the edge part of the annular edge part.

6. The spindle motor as set forth in claim 1, wherein the stator core part includes:
a stator core formed by stacking a plurality of metal plates; and
a coil wound around an outer peripheral surface of the stator core several times.

7. The spindle motor as set forth in claim 1, further comprising:
a printed circuit board coupled to an upper portion of the base plate and applying power to the stator core part; and
a disk chucking device coupled to an upper surface of the rotor case.
